(19) United States
(12) Patent Application Publication
(10) Pub. No.: US 2008/0133783 A1
(43) Pub. Date: Jun. 5, 2008

(54) COMPUTER INFORMATION PANEL

(76) Inventor: Stan Cheng, Taipei (TW)

Correspondence Address: BIRCH STEWART KOLASCH & BIRCH, PO BOX 747, FALLS CHURCH, VA, 22040-0747, US

(21) Appl. No.: 12/018,044

(22) Filed: Jan. 22, 2008

Related U.S. Application Data
(63) Continuation-in-part of application No. 10/759,761, filed on Jan. 16, 2004.

(51) Int. Cl. G06F 3/00

(52) U.S. Cl. 710/19

(57) ABSTRACT

A computer information panel to display status information of computer hardware, or information of a software operation system or remote ends of a networks through a USB interface includes an information processing device to receive the information of a computer system, a display device coupling on the information processing device, a driving circuit to receive signals of a controller to drive the display device to display the status information and a power supply which has at least one power supply module to supply electric power to the display device for displaying.

This application is a continuation-in-part, and claims priority, of from U.S. patent application Ser. No. 10/759,761 filed on Jan. 16, 2004, entitled “FRONT PANEL WITH SYSTEM INFORMATION”.

### FIELD OF THE INVENTION

The present invention relates to a computer information panel and particularly to a computer information panel to display operation status of a computer system, or information of a software operation system or remote ends of a networks through a USB interface.

### BACKGROUND OF THE INVENTION

Advance of technology makes computer performance more powerful at a lower price. The present computer allows information to be sent to a display panel for displaying through a serial port (such as RS-232) or a parallel port (such as a printer port). In the earlier time a personal computer has a display panel on the chassis including seven segments to display CPU duty clock, but cannot display character and numeric data. U.S. Pat. No. 7,034,777 discloses an external mini monitor which is connected to a Computer host through a peripheral bus (such as USB) to aid the main monitor to display computer information to facilitate user operation. However, the driving power of the mini monitor is provided by the USB, the information displaying function is available only when the computer is power on. When the computer host is power off no information can be displayed. It leaves a lot to be desired.

Hence there is a need to provide a computer information panel to receive information through a USB interface to improve receiving speed and operation status of the computer and display the information, and also display time when the computer is power off.

### SUMMARY OF THE INVENTION

The present invention aims to provide a computer information panel connecting to a USB interface to display operation status of a computer system, or information of a software operation system or remote ends of a network, and also display the real time when the computer system is power off.

The computer information panel according to the invention is connected to a USB interface to display operation status of a computer system, or receive and display information of remote ends of a network. It includes a USB interface connecting to the computer system to receive signals of operation, an information processing device to receive the signals through the USB interface, at least one controller connecting to the USB interface to receive the signals to control operation of the information processing device and a display device coupling with the information processing device that has a driving circuit to receive the signals of the controller to drive the display device to display the status information, and a power supply containing at least one power supply module to provide power for the display device to display the information.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention showing a computer information panel connecting to a computer system.

FIG. 2 is a structural block diagram of an embodiment of the computer information panel of the invention.

FIG. 3 is an operation block diagram of the software of the computer information panel of the invention.

### DETAILED DESCRIPTION OF THE PREFERRED EMBODIMENTS

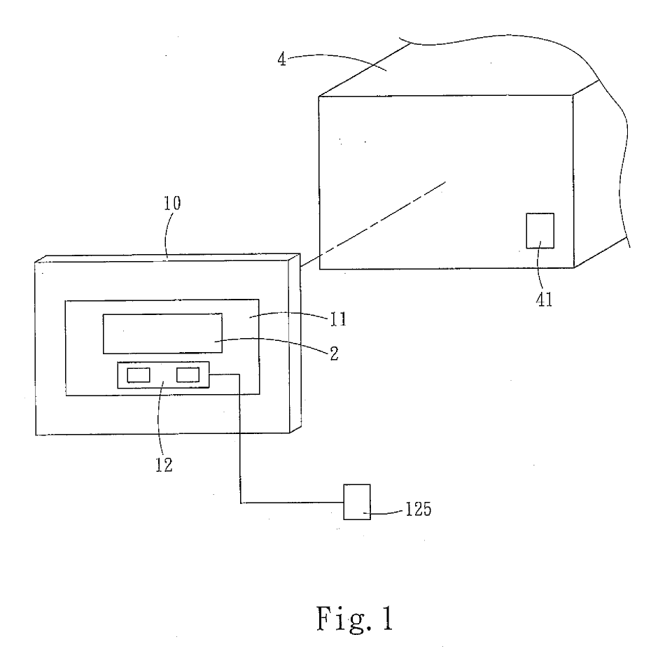

Please refer to FIG. 1 for an embodiment of the invention showing a computer information panel connecting to a computer system 4. The computer information panel of the invention is connected to a USB port 41 of the computer system 4 through a USB interface 125 to display status information of the computer system 4, processed information of an operation system or information received from remote ends of a network. The computer information panel includes a chassis 10, a circuit board 11, an information processing device 12, a display device 2 and a firmware system (not shown in the drawing). The computer information panel is connected to the USB port 41 of the computer system 4 through the USB interface 125 to receive signals of the information mentioned above and display on the display device 2. The computer system 4 includes at least one motherboard (not shown in the drawing), a central processing device, a basic I/O system (BIOS), a real time clock (RTC), a battery and a USB port 41. These are techniques known in the art, details are omitted.

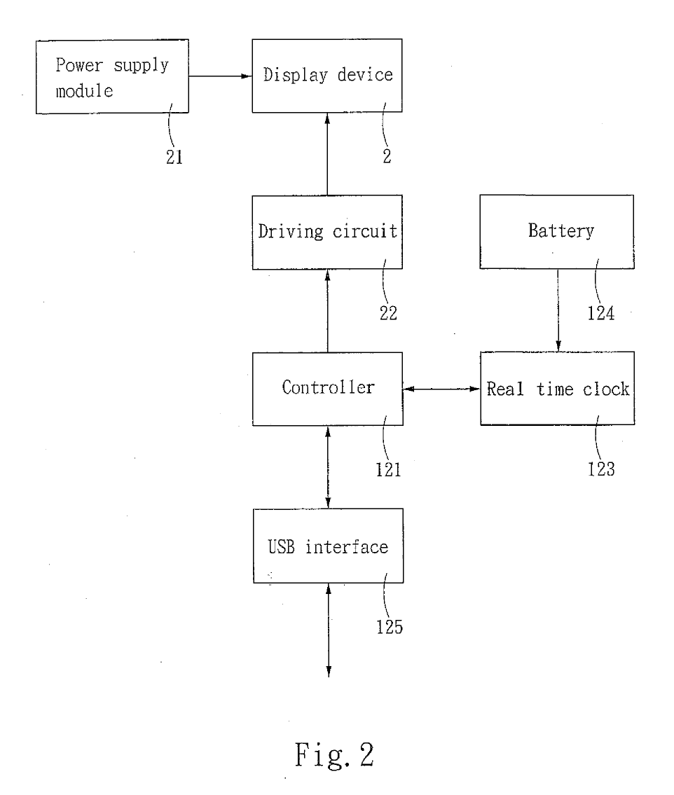

Refer to FIG. 2 for the structure of the computer information panel of the invention. The information processing device 12 includes at least a controller 121, a RTC 123, a battery 124 and a USB interface 125. The controller 121 is connected to the USB interface 125 to receive the signals. The firmware (not shown in the drawing) controls operation of the information processing device 12 and outputs related operation status to be displayed on the display device 2. The display device 2 may be, but not limited to, a LCD, LED, VFD or other display devices capable of displaying characters and numerals. It further includes a power supply module 21 and a driving circuit 22. The power supply module 21 is coupled with the display device 2 to supply electric power required for displaying on the display device 2. The driving circuit 22 is coupled to the controller 121 and display device 2 to receive signals sent by the controller 121 and drive the display device 2 to display the status information. The RTC 123 provides time information. The battery 124 is electrically connected to the RTC 123 to provide a required voltage for operation. When the computer system 4 is power ON or OFF the battery 124 provides a DC voltage to the RTC 123 for operation.

When the computer information panel of the invention is in use, the information is displayed as follow: 1. operation temperature of the CPU (not shown in the drawings) of the computer system 4 or rotation speed of air fans are displayed to inform users; other information such as CPU type and duty frequency, hard disk type (IDE or SCSI) and capacity and the like may also be displayed; 2. operation system information of the computer system 4 are processed by a driver and displayed on the display device 2 by linking of the USB interface 125 and USB port 41; 3. information of remote ends of the network after processed (such as advertising data) by the operation system (not shown in the drawings) and also by the driver, and displayed on the display device 2 by linking to the USB interface 125 and USB port 41; and 4. when the computer information panel is power on, the battery 124 supplies electric power to display the real time of the RTC 123 on the display device 2.

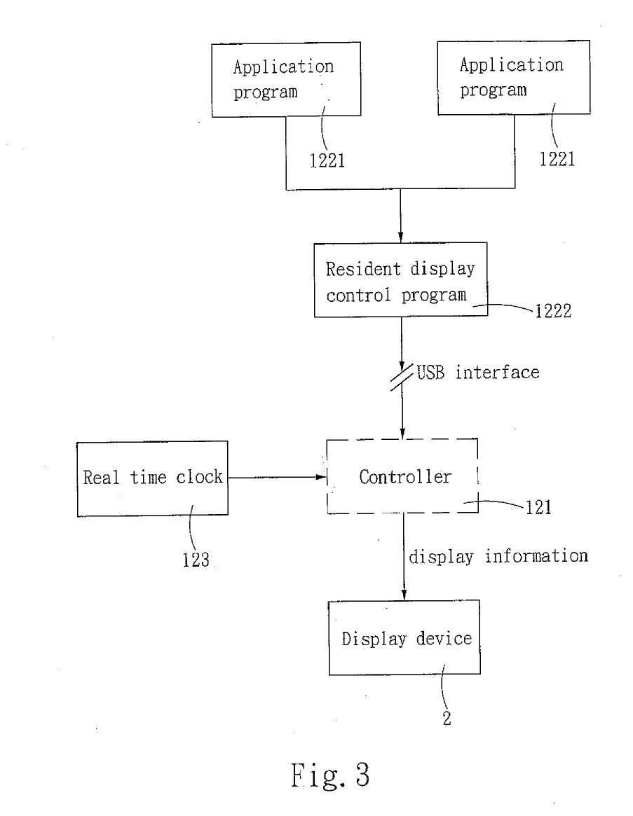

Refer to FIG. 3 for the operation block diagram of the software of the computer information panel of the invention. The computer information panel includes at least an application program 1221 and a resident display control program 1222. The application program 1221 can, but not limited to, monitor the operation temperature of the CPU of the computer system 4 or rotation speed of the air fans. When the application program 1221 receives the rotation speed information of the air fans from the CPU, the information is sent to the resident display control program 1222 and a firmware (not shown in the drawings) built in the controller 121 is driven to process the rotation speed information. The processed result is displayed on the display device 2 through the driving circuit 22 by characters and numerals such as 2000 RPM to facilitate user reading and improve user-friendliness of the invention. More other application programs 1221 may be added according to requirements such as capturing real times news or financial information from the Internet through the computer system 4. And these real time news or financial information can be displayed instantly on the computer information panel.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A computer information panel to display status information of a computer system, comprising:
a USB interface connecting to the computer system to receive signals of the status information;
an information processing device which receives the signals through the USB interface and includes at least one controller linking to the USB interface to get the signals to control operation of the information processing device; and
a display device which is coupled to the information processing device and has at least one driving circuit to receive the signals from the controller and drive the display device to display the status information and a power supply containing at least one power supply module to provide electric power for the display device to display.

2. The computer information panel of claim 1, wherein the controller has a firmware system.

3. The computer information panel of claim 1, wherein the information processing device has a real time clock to provide time information.

4. The computer information panel of claim 3, wherein the real time clock has a battery to provide a DC voltage required for operation thereof.

5. The computer information panel of claim 3, wherein the real time clock provides the time information to the display device when the computer system is power on.

6. The computer information panel of claim 3, wherein the real time clock provides the time information to the display device when the computer system is power off.

7. The computer information panel of claim 1, wherein the display device is selectively a liquid crystal display, a light emitting diode, a fluorescent lamp display or other display devices capable of displaying characters and numerals.

8. The computer information panel of claim 1, wherein the computer information panel also displays operation temperature of the computer system, CPU types, duty frequency or types and capacity of hard disks.

9. The computer information panel of claim 1, wherein the computer information panel also displays information of an operation system of computer system software.

10. The computer information panel of claim 1, wherein the computer information panel also displays information of remote ends of a network.

11. The computer information panel of claim 1 further including a resident display control program to drive the controller in the information processing device.

12. The computer information panel of claim 1 further including at least one application program connecting to the information processing device.

13. The computer information panel of claim 12, wherein the application program monitors and processes operation temperature of the computer system or rotation speed of air fans of the computer system.

14. The computer information panel of claim 12, wherein the application program captures real time news or financial information on the Internet of the computer system.
